(19) United States
(12) Patent Application Publication
(10) Pub. No.: US 2015/0350284 A1
(43) Pub. Date: Dec. 3, 2015

(54) Method of Enhancement of Data Transmission in Multimedia Service

(71) Applicant: Acer Incorporated, New Taipei City (TW)

(72) Inventors: Hung-Yu Wei, New Taipei City (TW); Ching-Chun Chou, New Taipei City (TW)

(21) Appl. No.: 14/708,304

(22) Filed: May 11, 2015

Related U.S. Application Data
(60) Provisional application No. 62/003,050, filed on May 27, 2014.

(51) Int. Cl. H04L 29/06; H04L 12/18; H04W 4/06

(52) U.S. Cl. CPC H04L 65/604; H04W 4/06; H04L 12/189; H04L 65/4076

(57) ABSTRACT

A method of enhancement of data transmission in multimedia service for a network in a wireless communication system is disclosed. The method comprises providing a video stream of the multimedia service to a mobile device of the wireless communication system, and transmitting an indication to the mobile device, wherein the indication including mapping information of a data stream of the multimedia service and the video stream.

### CROSS REFERENCE TO RELATED APPLICATIONS

This application claims the benefit of U.S. Provisional Application No. 62/003,050, filed on May 27, 2014 and entitled “Mechanism for MBMS datacasting”, the contents of which are incorporated herein in their entirety.

### BACKGROUND OF THE INVENTION

1. Field of the Invention

The present invention relates to a method used in a communication device in a wireless communication system, and more particularly, to a method of enhancement of data transmission in multimedia service.

2. Description of the Prior Art

Multicast-broadcast single-frequency network (MBSFN) is a communication channel defined in the Long Term Evolution (LTE) system. The transmission mode is intended as a further improvement of the efficiency of Multimedia Broadcast Multicast Service (MBMS), which can deliver services such as mobile TV using the LTE infrastructure, and is expected to compete with dedicated mobile/handheld TV broadcast systems such as Digital Video Broadcasting-Handheld (DVB-H) and Digital Video Broadcasting-Satellite services to Handhelds (DVB-SH). This enables network operators to offer mobile TV without the need for additional expensive licensed spectrum and without requiring new infrastructure and end-user devices.

In addition, 3GPP in Release 12 provides an enhanced MBMS operation, on-demand MBMS, for more flexibly and capability for 5G wireless communication. In detail, on-demand MBMS provides a mechanism to dynamically and seamlessly switch a unicast to a multicast one. If a unicast service is requested by a large amount of users, establishing numerous unicast to handle the request is a waste of radio resource. The mechanism of on-demand MBMS allows eNBs to switch unicast into multicast, for reducing the radio resource consumption. Please refer to FIG. 1, which illustrates a schematic diagram of MBMS content classifications. In FIG. 1, the MBMS content includes all kinds of information as part of the video frame. For example, a live basketball or baseball game may have scores, statistics and applications (i.e. paying/charging information or other interactive contents) displayed along with the live videos.

Thereafter, datacasting service, an enhanced feature of MBMS operation is defined and aims to provide MBMS data beyond the traditional MBMS content. Please refer to FIG. 2, which illustrates a schematic diagram of MBMS transmission according to the prior art. In FIG. 2, the data V1-V2 are conventionally distributed as part of the live video m1. In other words, the data V1-V2 are treated as figures, not formatted data, and encoded into video frames, which may cause overhead. Besides, the data V1-V2 are normally non-real time contents and may not require frequently updated as real-time contents (i.e. the live video m1). As a result, transmission of traditional MBMS content including both real-time and non-real-time contents results in low radio resource utilization.

Moreover, there are some multimedia services provide TV or digital contents over channels and interactions between users to provide customized services. For example, interactive television, raised by Interactive Television Alliance, it is a media convergence to add data services to TV technology. Interactive TV applications can be delivered over the broadcast channel, together with audio and video streams. These applications can be for example information services, games, interactive voting, e-mail, SMS or shopping. In addition, interactive TV application includes several user interactions with the program:

1. Interactivity with TV set: not changing video contents, like forwarding, rewinding, recoding, etc.

2. Interactivity with TV program contents: interact with video contents, like voting for the ending for a specific program.

3. Interactivity with TV-related contents: like television commerce.

Interactivity with TV-related contents is categorized as one-screen or two-screen interaction. One-screen interaction is to provide the service over the same television screen of the video. Such interaction is provided by TV set-up box, and includes advertisement, weather, sports, etc. For two-screen interactions, these services are provided through web broadcasting to computer, which is a different screen from the television. However, no video contents are distilled in such interactivity. The services are in parallel with the video, which may be not related to the video content.

For another multimedia service, like Digital Video Broadcasting-Multimedia Home Platform (DVB-MHP) defines broadcast framework to provide multimedia contents to users. It also includes links between internet services and broadcast services. For example, enhanced broadcasting combines digital broadcast of audio/video services with downloaded applications which can enable local interactivity. Interactive Broadcasting enables a range of interactive services associated or independent from broadcast services. Internet Access is intended for the provisioning of Internet services.

Please refer to FIG. 3, which illustrates application areas of enhanced broadcasting, interactive broadcasting and internet access and levels of profiles. In FIG. 3, different contents, including broadcast itself and interactive/network contents, are delivered through profiles and integrated as video graphics to the users. In addition, please refer to FIG. 4, which illustrates graphics models for display. As shown in FIG. 4, the essence of DVB-MHP is to integrate the contents from different profiles to generate different plane, and these planes are view by the viewers on the terminal screen. The DVB-MHP provides an integrated service to the users.

### SUMMARY OF THE INVENTION

It is there for an objective to provide a method of enhancement of data transmission in multimedia service to solve the above problem.

The present invention discloses a method of enhancement of data transmission in multimedia service for a network in a wireless communication system. The method comprises providing a video stream of the multimedia service to a mobile device of the wireless communication system, and transmitting an indication to the mobile device, wherein the indication including mapping information of a data stream of the multimedia service and the video stream.

The present invention further discloses a method of enhancement of data transmission in multimedia service, for a mobile device in a wireless communication system. The method comprises receiving a video stream of the multimedia service from a network of the wireless communication system, and receiving mapping information of a data stream of the multimedia service and the video stream, from the network, and applying the data stream for the video stream according to the mapping information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of MBMS content classifications.

FIG. 2 illustrates a schematic diagram of MBMS transmission according to the prior art.

FIG. 3 illustrates application areas of enhanced broadcasting, interactive broadcasting and internet access and levels of profiles.

FIG. 4 illustrates graphics models for display.

FIG. 5 illustrates a schematic diagram of a MBSFN deployment.

FIG. 6 illustrates a schematic diagram of an exemplary communication device.

FIG. 7 is a flowchart of an exemplary process according to the present disclosure.

FIG. 8 illustrates a schematic diagram of an exemplary MBMS content transmission.

FIGS. 9A-10B illustrates a schematic diagram of a location of a pointer.

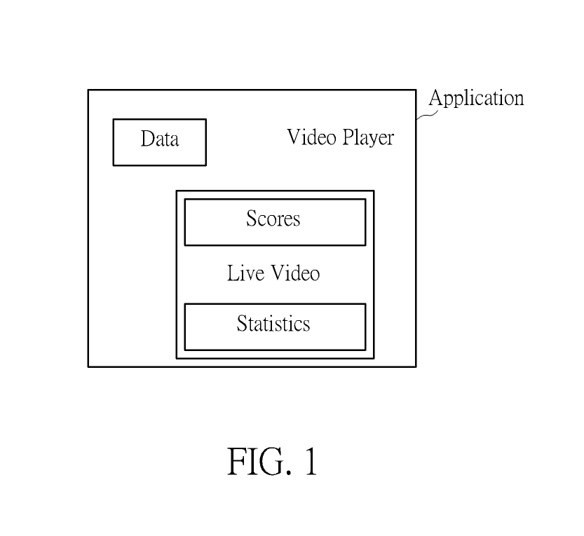

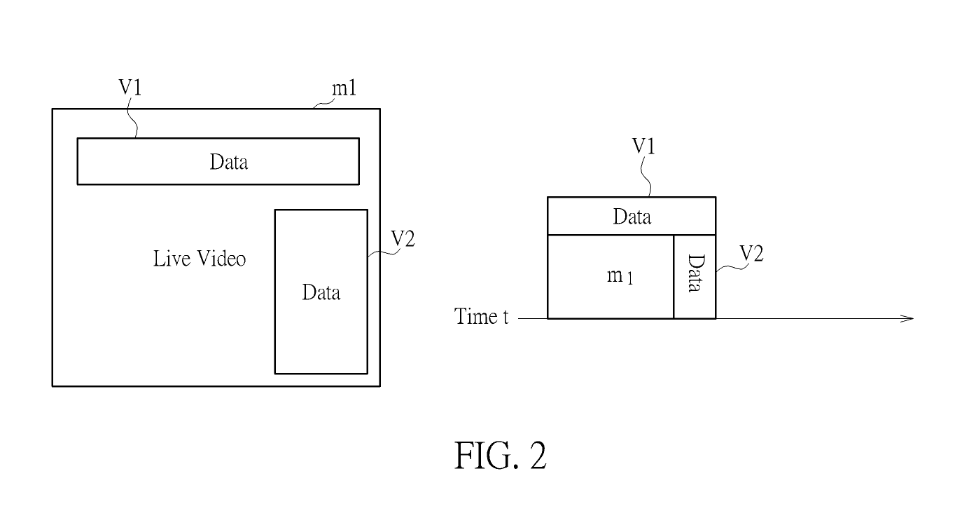

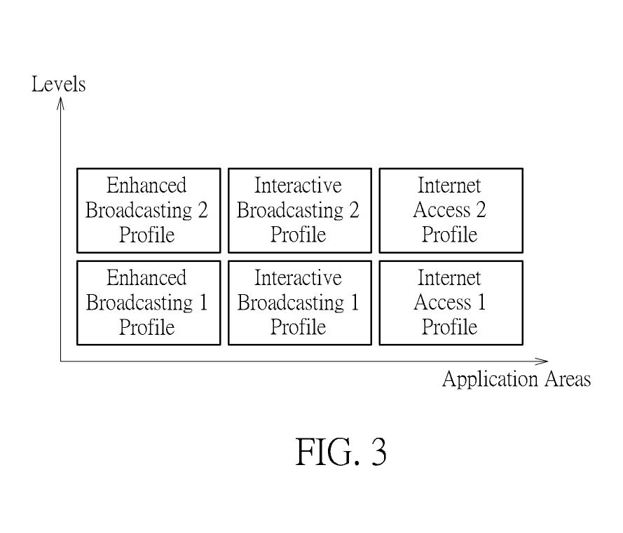

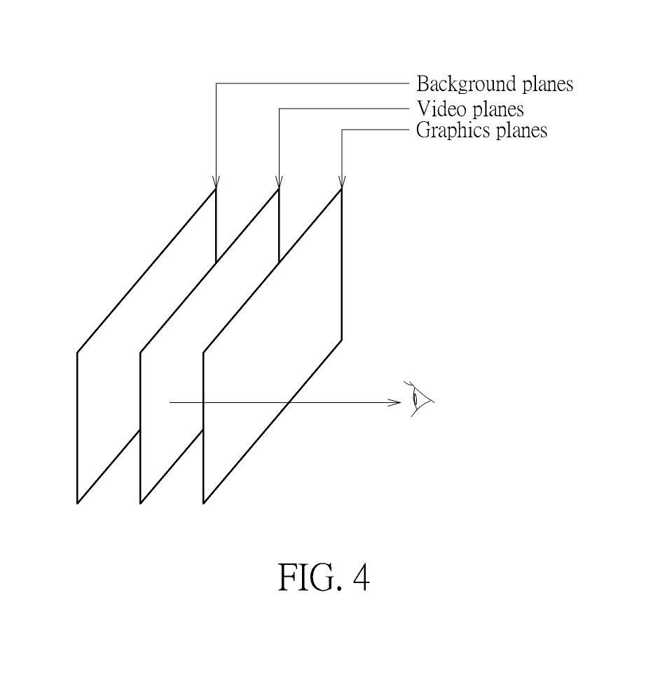

### DETAILED DESCRIPTION

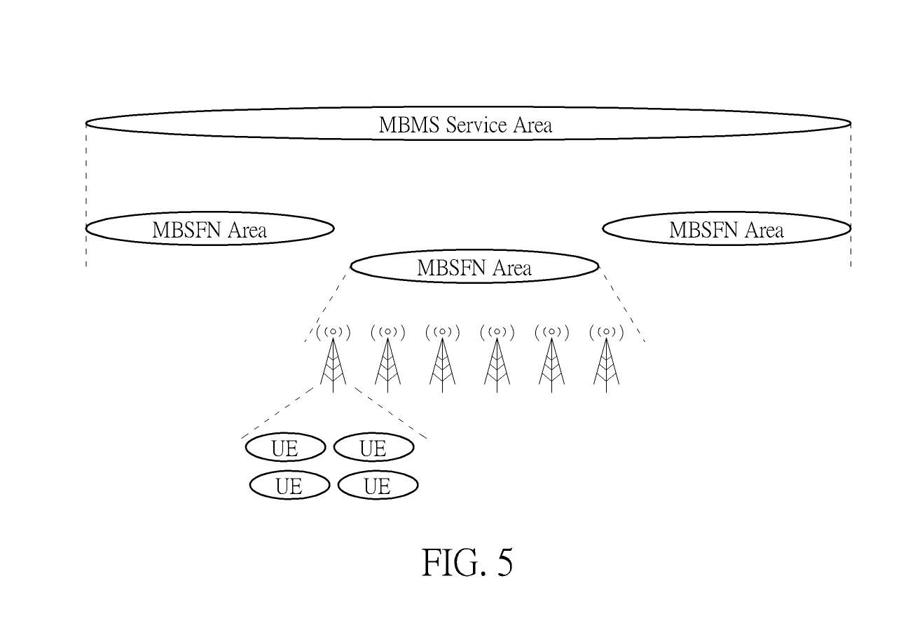

FIG. 5 illustrates a schematic diagram of a multicast-Broadcast Single Frequency Network (MBSFN) deployment in the LTE system. LTE specification supports for Multimedia Broadcast Multicast Service (MBMS), which is a multimedia service performed by MBSFN. In detail, MBMS is a point-to-multipoint service in which data is transmitted from a single source entity to multiple recipients. Transmitting the same data to multiple recipients allows network resources to be shared. In FIG. 5, the MBSFN Synchronization area is capable of supporting one or more MBSFN area and the MBSFN area is an area which consists of a group of cells within an MBSFN Synchronization Area. An MBSFN transmission from multiple cells within the MBSFN Area is seen as a single transmission by a UE. Overall concept for MBSFN transmission is as follows. An eNB can transmit the same data (i.e. MBMS) to multiple UEs simultaneously.

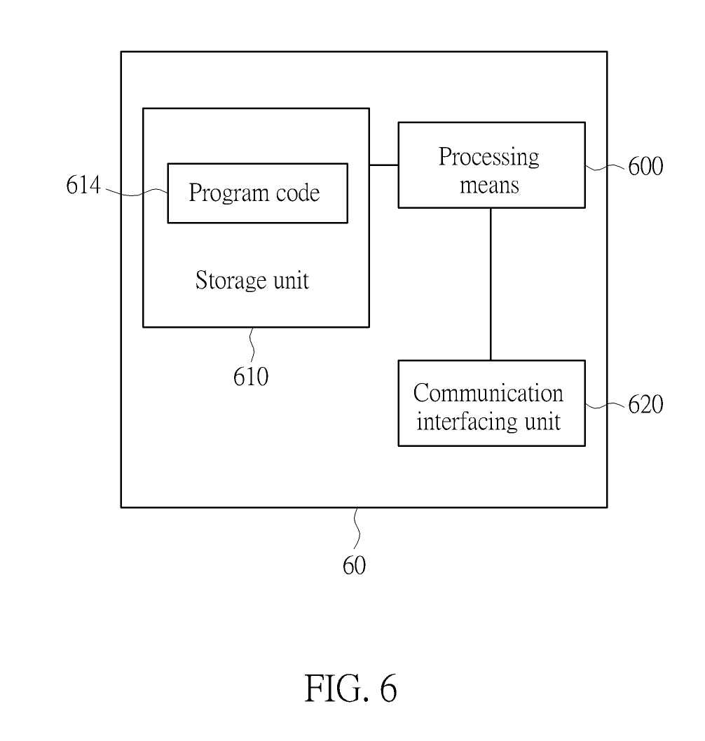

FIG. 6 illustrates a schematic diagram of an exemplary communication device 60. The communication device 60 can be the UE or eNB shown in FIG. 5. The communication device 60 may include a processing means 600 such as a microprocessor or Application Specific Integrated Circuit (ASIC), a storage unit 610 and a communication interfacing unit 620. The storage unit 610 may be any data storage device that can store program code 614, for access by the processing means 600. Examples of the storage unit 610 include but are not limited to a subscriber identity module (SIM), read-only memory (ROM), flash memory, random-access memory (RAM), CD-ROMs, magnetic tape, hard disk, and optical data storage device. The communication interfacing unit 620 is preferably a radio transceiver and can exchange wireless signals with a network (i.e. E-UTRAN) according to processing results of the processing means 600.

In order to satisfy the next generation wireless multicast requirement, the applicant considers the case of MBMS contents distribution, in view of datacasting service.

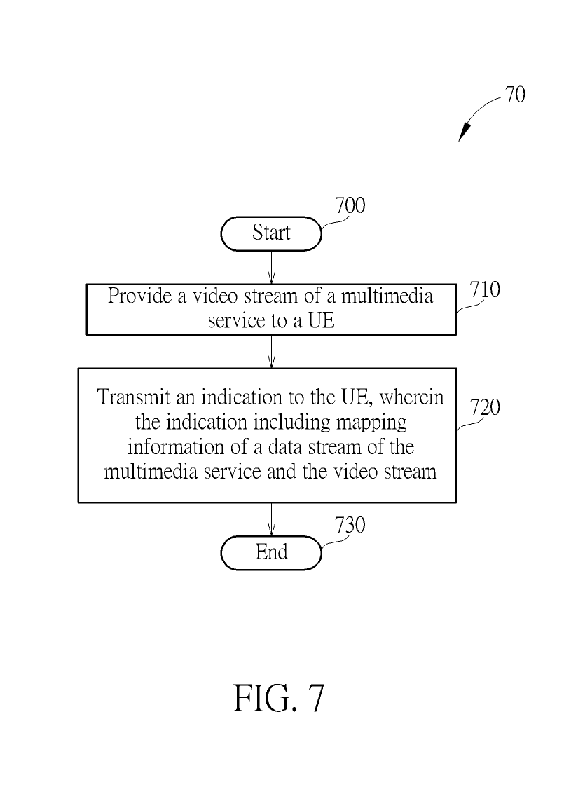

Please refer to FIG. 7, which is a flowchart of a process 70 according to an example of the present disclosure. The process 70 is utilized in the communication device 60 (i.e. the eNB in FIG. 5) for data transmission in multimedia service. The process 70 may be compiled into a program code 614 to be stored in the storage unit 610, and may include the following steps:

Step 700: Start.

Step 710: Provide a video stream of a multimedia service to a UE.

Step 720: Transmit an indication to the UE, wherein the indication including mapping information of a data stream of the multimedia service and the video stream.

Step 730: End.

According to the process 70, the eNB provides a signal (i.e. an indication or a pointer) for mapping the data stream to the video stream of the multimedia service to the UE. Therefore, the UE knows the received data stream is applied for which video stream according to the indication or pointer when the UE receives the data stream from the eNB. As a result, data stream and video stream can be separately transmitted, so as to avoid overhead and enhance radio resource utilization.

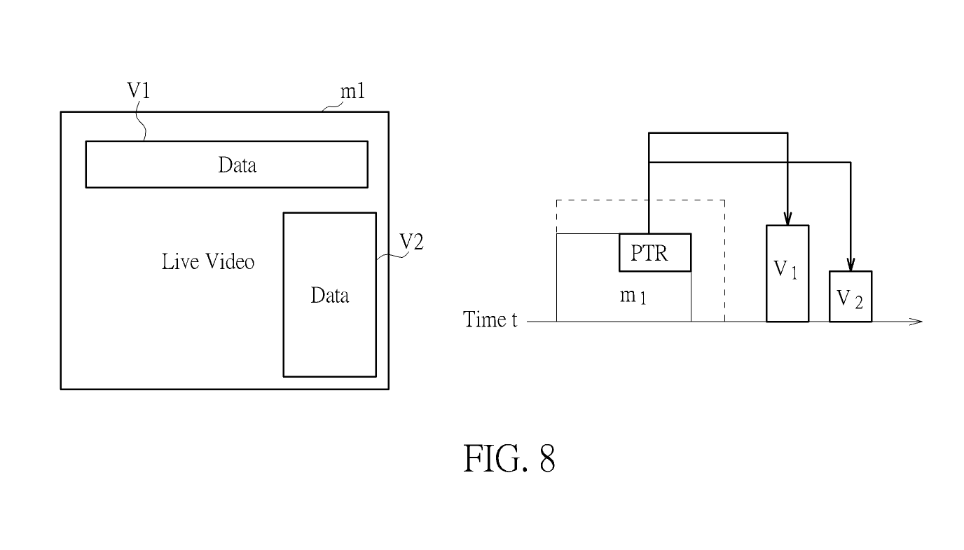

In detail, please refer to FIG. 8, which illustrate a schematic diagram of MBMS transmission according to the present invention. In FIG. 8, a pointer PTR is included in live video m1 for indicating mapping information of the live video m1 and the data V1-V2. As can be seen, the data V1-V2 are not transmitted along with live video m1, but transmitted separately.

In a word, the process 70 proposes a datacasting method for MBMS operation of the LTE system. In detail, the process 70 can map one or multiple MBMS data to one or multiple MBMS video. Take basketball game for example. Some statistics are valid only in one MBMS video, like score boards or in-game player statistics. In this case, there maybe one or multiple datacasting service dedicated for the MBMS video. However, some datacasting service is valid throughout multiple MBMS videos, like the scores of all the games within the same day, the timetable of all the live shows, etc. Multiple MBMS videos may utilize the same datacasting service for their audience. In this case, datacasting service coverage is equal or larger than the MBMS video coverage. As abovementioned, the mapping between video stream and data stream of the MBMS content may be 1-1, 1-M, M-1 or M-M mapping.

Note that, the process 70 may be not limited in MBMS operation of the LTE system, but can be used for other multimedia service with datacasting.

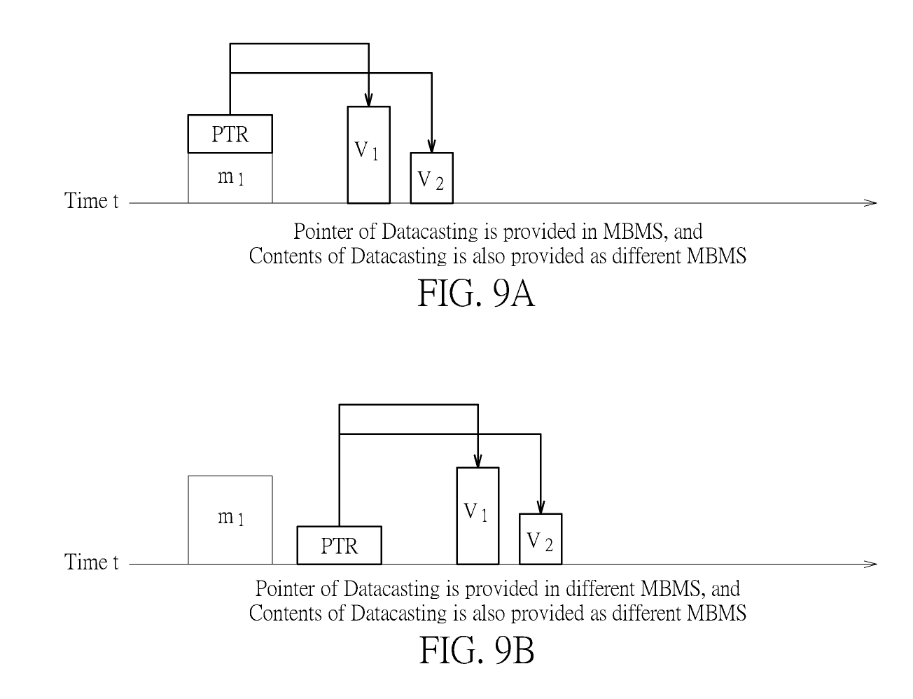

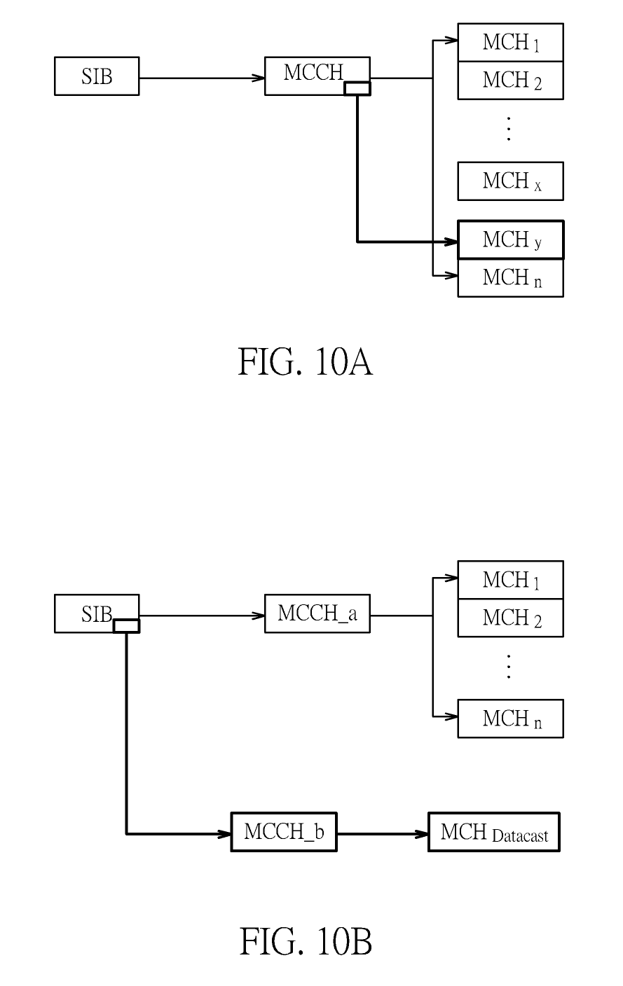

In an embodiment, the indication or pointer may be provided as multicast or unicast. Or, the indication or pointer maybe located along with the MBMS video or separated signaling. Please refer to FIG. 9A, which illustrates a schematic diagram of a location of a pointer PTR. In FIG. 10A, the pointer PTR is provided in a live video m1 to indicate mapping information of the live video m1 and data V1-V2. Therefore, the data V1-V2 can be transmitted separately from the live video m1 (i.e. in different data channel) and could be applied correctly to the live video m1 by the UE. In FIG. 9B, the pointer PTR is not provided in the live video m1, but in a dedicated resource or different live video to indicate mapping information of the live video m1 and data V1-V2.

Moreover, the indication or the pointer may be provided in system information block 13 (SIB13), MBMS control channel (MCCH) or MBMS data channel (MCH) . The indication/pointer may indicate location of resource blocks, subframes, carriers, etc. Or, the indication/pointer may be provided in forms of server IP, URL, data object identifier (DOI) for mapping scheme realization. Please refer to FIGS. 10A-10B, which illustrates a schematic diagram of resource allocation for the indication/pointer. In FIG. 10A, the indication/pointer is provided in the MCCH and indicates to one or more than one MCH of the MCCH. In this case, MCHy is indicated as MBMS data for MBMS video in MCH₁-MCHₙ of the MCCH. Note that, mapping between MCHx (namely any of MCH of MCCH) and MCHy includes 1-1, 1-N, N-1 or N-N.

On the other hand, in FIG. 10B, the indication/pointer is provided in SIB13 and indicates to MCCH_b. In other words, MCCH_b is indicated as MBMS data for MBMS video within MCCH_a, wherein MCCH_a may include multiple MCHs, MCH₁-MCHₙ, and MCCH_b may include one MCH_{Datacast}.

The abovementioned steps of the processes including suggested steps can be realized by means that could be a hardware, a firmware known as a combination of a hardware device and computer instructions and data that reside as read-only software on the hardware device or an electronic system. Examples of hardware can include analog, digital and mixed circuits known as microcircuit, microchip, or silicon chip. Examples of the electronic system can include a system on chip (SOC), system in package (SiP), a computer on module (COM) and the communication device 60.

In conclusion, the present invention provides a data transmission method for multimedia service. In detail, the present invention proposes a signaling mechanism (i.e. an indication/pointer) to provide mapping between video stream and data stream of the multimedia service, so as to distill data steam from video stream. In addition, data stream may be applied for multiple video streams to reduce radio resource consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of enhancement of data transmission in multimedia service for a network in a wireless communication system, comprising:
providing a video stream of the multimedia service to a mobile device of the wireless communication system; and
transmitting an indication to the mobile device, wherein the indication including mapping information of a data stream of the multimedia service and the video stream.

2. The method of claim 1, wherein the indication is provided within the video stream or a dedicated resource.

3. The method of claim 1, wherein the indication is a pointer residing in a system information block (SIB), a MBMS control channel (MCCH) or MBMS data channel (MCH).

4. The method of claim 1, wherein the data stream is real-time contents or non-real time contents.

5. A method of enhancement of data transmission in multimedia service, for a mobile device in a wireless communication system, comprising:
receiving a video stream of the multimedia service from a network of the wireless communication system;
receiving mapping information of a data stream of the multimedia service and the video stream, from the network; and
applying the data stream for the video stream according to the mapping information.

6. The method of claim 5, wherein receiving the mapping information of the data stream of the multimedia service and the video stream, from the network comprises:
receiving an indication including the mapping information from the network; or
receiving the indication in a system information block (SIB), a MBMS control channel (MCCH) or MBMS data channel (MCH).
